(19) United States
(12) Patent Application Publication
(10) Pub. No.: US 2012/0068094 A1
(43) Pub. Date: Mar. 22, 2012

(54) Apparatus and Method for Remotely Operating Manual Valves

(76) Inventor: Kenneth Michael Terrell, Lake Jackson, TX (US)

(21) Appl. No.: 13/321,640

(22) PCT Filed: May 13, 2010
(86) PCT No.: PCT/US10/34719

§ 371 Date: Dec. 6, 2011

Related U.S. Application Data
(60) Provisional application No. 61/180,339, filed on May 21, 2009.

(51) Int. Cl. F16K 31/00

(52) U.S. Cl. 251/14

(57) ABSTRACT

An apparatus for remotely operating a manual valve is disclosed that includes a control unit, a valve actuator, a lock assembly, and a load cell. In some aspects, the apparatus may also include a stand such as a tripod. In another aspect, the apparatus may be portable and sometimes mounted on a vehicle or other form of transport.

### BACKGROUND OF THE DISCLOSURE

1. Field of the Disclosure

The disclosure relates to operating manual valves. The disclosure particularly relates to operating manual valves remotely

2. Description of the Prior Art

Manual valves are those valves that are normally operated by hand. However, in a chemical plant or a refinery, some valves may be inherently dangerous to operate by hand. In such circumstances, it is often preferable to install automated valves that are configured for remote operation.

Use of such automated valves can be undesirable. For example, the costs of automatic valves is often much greater than that for manual valves. Automatic valves often require much more maintenance since they have more components and are actuated using compressed gases or electricity.

Under some circumstance, valves that would be safe to operate manually under normal conditions may become subject to a greater risk for an operator. For example, when a chemical plant is undergoing maintenance or is subject to an operations upset, part of the facility that is normally relatively safe may become quite hazardous. Under those conditions it may be desirable to operate a manual valve remotely.

### SUMMARY OF THE DISCLOSURE

In one aspect, an apparatus for remotely operating a manual valve is disclosed that includes a control unit, a valve actuator, a lock assembly, and a load cell. In some aspects, the apparatus may also include a stand such as a tripod. In another aspect, the apparatus may be portable and may be mounted on a vehicle or other form of transport.

In another aspect, a method of remotely operating a manual valve is disclosed that includes employing an apparatus for remotely operating a manual valve that includes a control unit, a valve actuator, a lock assembly, and a load cell to remotely operate a manual valve. In some embodiments, data from the load cell is used to ensure that the torque limits of the valve are not exceeded. In still another aspect, the apparatus is portable and is transported to the valve to be operated using a vehicle or other form of transport.

### BRIEF DESCRIPTION OF THE DRAWINGS

The disclosure is best understood with reference to the accompanying figures in which like numerals generally refer to like elements, and in which:

FIG. 1 is an illustration of an embodiment of a device of the disclosure shown attached to a valve wheel;

FIG. 2 is a schematic representation of the locking device attached to a valve wheel; and

FIG. 3 is a schematic representation of another embodiment of a device of the disclosure further including a stand.

### DESCRIPTION OF THE EMBODIMENTS OF THE DISCLOSURE

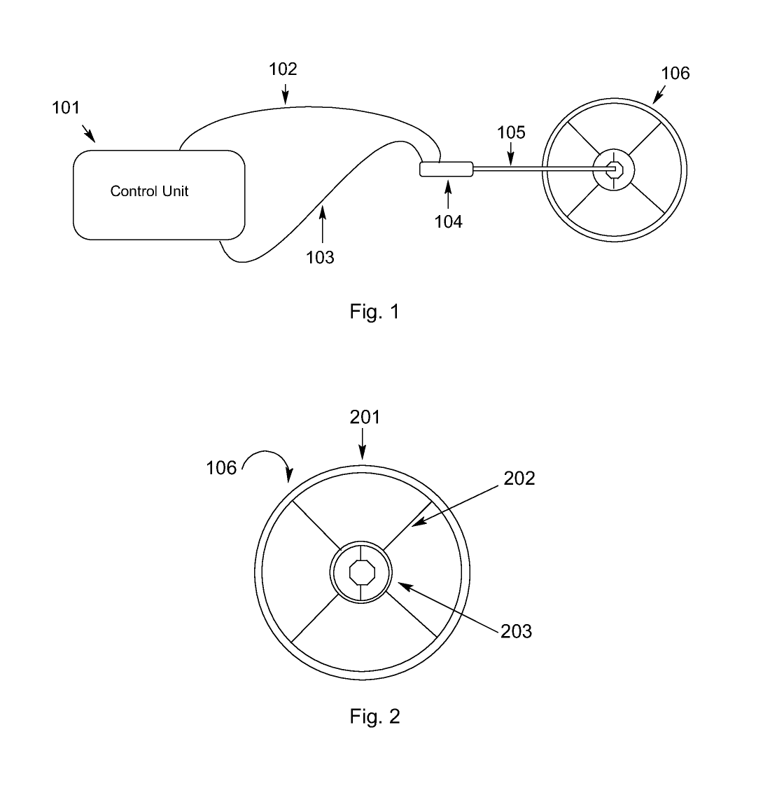

FIG. 1 is an illustration of an embodiment of a device of the disclosure shown attached to a valve wheel. While this embodiment is shown attached to a wheel of a valve, the apparatus may be used with any type of manual valve, including those operated with a handle or other member that may be manipulated to change an operating state of the valve. As used herein, the term “manual” refers the use of human power, as opposed to machine-generated power, to shift a valve between operating states. The devices and methods of this disclosure may be used with any type of flow control device including, but not limited to butterfly valves, choke valves, check valves, non-return valves, diaphragm valves, expansion valves, gate valves, globe valves, knife valves, needle valves, piston valves, pinch valves, and plug valves. As used herein, the term “valve” encompasses all such devices. Any valve that may be actuated by moving a structural member, e,g., by turning a handle or wheel, may be used with the method and apparatus of the disclosure.

Referring to FIG. 1, there is shown an apparatus for remotely activating a valve. As will be appreciated, the apparatus can be in a de-activated state as long as human personnel can access and locally manipulate a wheel 106 of the valve. Thus, under “normal” conditions, the valve may be opened or closed by human personnel rotating the wheel 106. During an “out of norm” situation, such as if ambient temperatures render the valve inaccessible to humans, the apparatus may be activated to open or close the valve. Illustrative “out of norm” conditions include environmental conditions such as elevated temperatures and water incursion and safety conditions such as the presence of hazardous substances.

In one embodiment, the apparatus includes a control unit 101 that has a gas line 102 connected to a valve actuator 104. A torsion shaft 105 connects the valve actuator 104 to a valve wheel and lock assembly 106. The gas line 102 may include two separate lines; one conveying gas for directional control, and the other providing motive force to move the valve. In one sense, directional control may include directing or re-directing the pressurized gas in a manner that moves an element (e.g., a piston) in two different directions.

Also shown is a data line 103, which functions to carry data from a load cell (not shown) back to the control unit 101 and/or carry commands to valve actuator.

In one mode of use, the apparatus may be connected to a valve. As shown FIG. 1, the valve may be actuated between two or more operating positions using a wheel and lock assembly 106. The control unit 101 may, in some embodiments, control the flow rate of gas through the gas line 102 to the valve actuator 104. The flow of gas is used by the valve actuator 104 to apply a torque to the torsion shaft 105. The torsion shaft 105 transfers this torsional force to the lock assembly and valve wheel. When the applied torque overcomes the force (frictional or otherwise) holding the wheel in place, the wheel turns thereby opening or closing the valve. The use of compressed gas in gas line 102 to generate torque is illustrative and exemplary only, as torque may be generated using other means, including but not limited to a pressurized fluids and electricity. For example, in certain embodiments, the apparatus may be powered by electricity rather than a pressurized fluid. That is, an electric motor may receive power from the control unit 101. In still other embodiments, a local power source, such as a battery or pressurized fluid, may be used.

The data line 103 may be a cable or other suitable conductor for conveying signals. The signals may be commands that instruct the actuator 104 to turn off or on, or may be other signals such as commands to control the direction of rotation of the valve actuator, usually clockwise and counterclockwise.

In still another embodiment, the data line 103 is used to both receive data from a load cell and also to control the direction of rotation of the valve actuator, even when a compressed gas is used.

Referring to FIG. 2, shown is a schematic representation of the locking device attached to a valve wheel 106. The locking device may include the outer rim 201 of the wheel 106, a spoke 202 of the wheel 106, and a locking assembly 203 connected onto the hub 205 of the wheel 106. While the configuration as shown has the locking assembly attached at the hub 205 of the valve wheel, the locking assembly 203 may be attached to the spokes 202, the outer rim 201 of the wheel 106, or any other portion of the wheel 106.

In another embodiment, the valve is controlled using a handle rather than a wheel. In this embodiment, the locking assembly may include a cage assembly and piston to move the handle and actuate the valve. In such embodiments, the actuator 104 may translate the shaft 105 along a linear or semi-linear path rather than rotating the shaft 105. It should be understood, however, that the actuator 104 and the shaft 105 in any manner needed to operate a valve.

In embodiments where the apparatus has sufficient power to damage the valve, a load cell (not shown) may be employed to control the power applied to the valve wheel or handle. For example, the load cell may be connected to a portion of the wheel. The load cell may also be connected a component of the valve actuator 104.

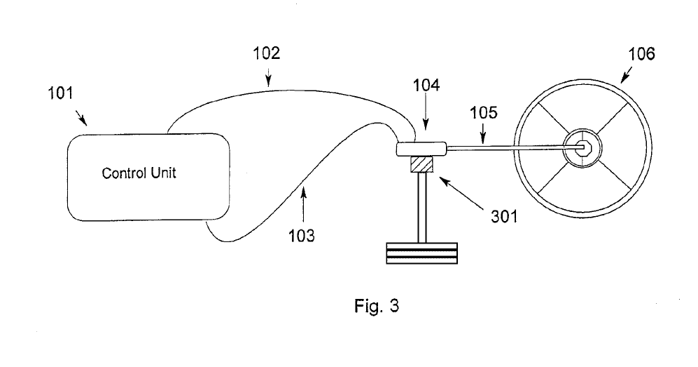

Referring to FIG. 3, shown is a schematic representation of another embodiment of an apparatus of the disclosure further including a stand 301. The stand may be sized and shaped to position the actuator 104 next to the valve wheel 106. While the stand 301 is shown as having a single stem or leg and being configured to rest on a floor, the stand 301 may have two or more legs and may be connected to a wall, a ceiling or other structure such as a valve housing. Thus, any type of stand or support for the valve actuator may be used.

In some embodiments of the invention, the control unit 101 may be mounted or positioned on a movable platform. The degree of portability provided by the platform may vary depending upon the requirements of the application. For example, where stronger forces are needed, it may be desirable that the apparatus be mounted in a motor vehicle or on a cart. In some embodiments, the control unit 101 may be light enough to be hand carried. In still other embodiments, each apparatus need not have a dedicated control unit 101. For example, a single control unit 101 may be used to operate two or more valve actuators 104. Such an operation can be simultaneously, e.g., two valve actuators may be connected to one control unit. The operation can also be sequential, e.g., a control unit may be connected to one valve actuator, then disconnected and re-connected to another valve actuator.

In alternative embodiments of the disclosure, the torsion shaft 105 may be incorporated into the body of the valve actuator 104. That is, the member for transferring the power generated by the valve actuator 104 to the valve wheel 106 may be at least partially internal to the valve actuator 104. In some embodiments, the torsion shaft may have an extended length and be flexible so that the device may be employed with valves having difficult to reach wheels or handles.

The controller 101 may include a timer that inserts a time delay between when an operator activates the controller 101 and when the controller 101 transmits a desired signal. For example, the timer may be activated to delay the actuation of a valve for a period sufficient to allow for evacuation of the operator. Alternatively, the controller may include a wireless receiver/transmitter allowing it to be operated from a safe distance in applications where there is a chance of, for example, an explosion.

As indicated above, in some embodiments, the apparatus may be employed to open or close a valve. In other embodiments, the apparatus may be configured such that it can only open or only close a valve.

What is claimed is:

1. An apparatus for operating a valve having an actuating member, comprising:
a movable member configured to connect to the actuating member;
an actuator operably coupled to the movable member; and
a control unit connected to the actuator.

2. The apparatus of claim 1, further comprising a carrier connecting the control unit to the actuator, wherein the carrier conveys one of: (i) a pressurized fluid, and (ii) signals.

3. The apparatus of claim 1 wherein the movable member is a torsion bar.

4. The apparatus of claim 3 wherein the actuator is configured to rotate the torsion bar.

5. The apparatus of claim 1 wherein the actuator is energized by one of: (i) pressurized fluid, and (ii) electrical power.

6. The apparatus of claim 1 further comprising a stand configured to receive the actuator.

7. The apparatus of claim 1, further comprising: a movable platform on which the control unit is mounted.

8. The apparatus of claim 1, further comprising: a load cell responsive to a load applied by the actuator.

9. A method of operating a valve having an actuating member, comprising:
connecting an actuator to the actuating member;
locally activating the valve by displacing the movable member without using the actuator; and
remotely activating the valve by energizing the actuator.

10. The method of claim 9, monitoring a condition of interest, and wherein the valve is remotely activated in response to the monitored condition.

11. The method of claim 10, wherein the condition of interest is one of: (i) a safety condition, and (ii) an environmental condition.

12. The method of claim 9, wherein the movable member is manually displaced.

13. The method of claim 9, further comprising rotating the actuating member using the actuator.

14. The method of claim 9, further comprising detecting a load applied to the actuating member by the movable member.
